(19) United States
(12) Patent Application Publication
(10) Pub. No.: US 2020/0373719 A1
(43) Pub. Date: Nov. 26, 2020

(54) CARBON BRUSH UNIT FOR A DIRECT CURRENT-EXCITED BRUSHED MOTOR WITH TARGETED HEAT DISSIPATION

(71) Applicant: NIDEC Motors & Actuators (Germany) GmbH, Bietigheim-Bissingen (DE)

(72) Inventor: Markus SCHOEBERL, Illingen (DE)

(21) Appl. No.: 16/881,600

(22) Filed: May 22, 2020

(30) Foreign Application Priority Data
May 24, 2019 (DE) 10 2019 113 915.5

(51) Int. Cl. H01R 39/26; H01R 39/02; H01R 39/38

(52) U.S. Cl. CPC H01R 39/26; H01R 39/388; H01R 39/022

(57) ABSTRACT

A carbon brush unit for a direct current-excited brushed motor may include a carbon brush and a carbon brush holder which is formed to receive the carbon brush. An outer side of the carbon brush and/or an inner side of the carbon brush holder are formed such that in the assembled state of the carbon brush unit defined contact regions and air channels located therebetween result between the outer side of the carbon brush and the inner side of the carbon brush holder in order to dissipate heat, wherein the contact regions are less than 60% of the overall surface of the inner side of the carbon brush holder, wherein the outer side of the carbon brush has a nanostructuring which forms the defined contact regions and air channels.

### CROSS-REFERENCE TO RELATED APPLICATION

This application claims priority under 35 U.S.C. § 119(b) to German Patent Application No. 10 2019 113 915.5, filed May 24, 2019, the disclosure of which is incorporated herein by reference.

The present invention relates to a carbon brush unit for a direct current-excited brushed motor and to a direct current-excited brushed motor.

In the case of commutator motors, the current is supplied from the power supply or the control device via carbon brushes which abut against the commutator divided into a plurality of lamellae and used for commutation. The lamellae are isolated from one another on the circumference of the commutator and are accordingly powered successively via the carbon brushes when the rotor formed by the armature windings, motor shaft and commutator rotates. It is known to receive or guide the carbon brushes in carbon brush holders. The carbon brush holders are arranged on a support plate of a brush holder unit and are aligned radially or axially. In each case one connection lead is guided from the carbon brushes held in the holders to an electric component held on the support plate. The carbon brush is arranged in the carbon brush holder with certain tolerance conditions, whereby play results. This play is compensated by a contact surface of the carbon brush. During actual operation, the carbon brush is pressed against the commutator lamellae of the direct current motor by means of a pressure spring.

The correct mounting of the carbon brush in the carbon brush holder is crucial for reliable contact of the lamellae. During permanent operation of the motor, an increase in the temperature and temperature-related adhesion or sticking of the carbon brush to the carbon brush holder may result which has a negative influence on the running properties of the motor.

It is known from the prior art to use costly carbon brush holders made of brass which have metal cooling ribs and thus dissipate the heat.

The object of the present invention is to indicate a carbon brush unit for a direct current-excited brushed motor, with the carbon brush, depending on the temperature, adopting a stable position in a carbon brush holder of a brush holder unit.

This object may be achieved by a carbon brush unit for direct current-excited brushed motor with features as set forth in one or more of the attached claims.

Accordingly, a carbon brush unit for a direct current-excited brushed motor having a carbon brush and a carbon brush holder is provided which is formed to receive the carbon brush, with an outer side of the carbon brush and/or an inner side of the carbon brush holder being formed such that in the assembled state of the carbon brush unit defined contact regions and air channels located therebetween result between the outer side of the carbon brush and the inner side of the carbon brush holder in order to dissipate heat, with the contact regions being less than 60% of the overall surface of the inner side of the carbon brush holder, preferably less than 40%. The outer side of the carbon brush has a nanostructuring which forms the defined contact regions and air channels. Heat can be targetedly dissipated via the air channels, whereby adhesion of the carbon brush in the carbon brush holder can be prevented.

The nanostructuring is preferably formed by means of laser interference. The nanostructuring here preferably has structure periods in a range of between 500 nm to 2000 nm. The nanostructuring can have spherical, pyramid-shaped and/or roof-shaped protrusions. The contact regions are preferably in a punctiform or linear manner. In a preferred embodiment, the nanostructuring is formed in the manner of shark skin. It can also be provided that the nanostructuring is formed by a surface coating which for example has a trioctaedric octahedron layer.

The air channels can also be formed by structuring of the surface of the inner side of the carbon brush holder, with the structuring preferably having structure periods in the range of 0.1 mm to 10 mm.

Moreover, a carbon brush unit for a direct current-excited brushed motor having a carbon brush and a carbon brush holder is provided which is formed to receive the carbon brush, with an outer side of the carbon brush and/or an inner side of the carbon brush holder being formed such that in the assembled state of the carbon brush unit defined contact regions and air channels located therebetween result between the outer side of the carbon brush and the inner side of the carbon brush holder in order to dissipate heat, with the contact regions being less than 60% of the overall surface of the inner side of the carbon brush holder, preferably less than 40%. The contact regions and air channels are formed by an adapted geometry of the carbon brush and/or of the carbon brush holder. The air channels or contact regions are then of a size in the range of mm. In order to support the removal of heat, a highly heat-conductive material is applied in the region of the contact regions on the outer side of the carbon brush.

It is advantageous here when the carbon brush has on the outer side and/or the carbon holder has on the inner side a geometry deviating from a geometry that is rectangular in the longitudinal section, which in the assembled state of the unit forms the contact regions and defined air channels. Preferably, the carbon brushes have on the outer side and the carbon brush holder has on the inner side at least partially a corresponding geometry which is formed such that the two components are engaged with one another, with the engagement providing a defined position of the carbon brush in the carbon brush holder. This engagement can for example be formed via a groove-to-web connection. In order to form the most extensive air channels possible, the contact region is preferably limited to the region of the engagement.

Moreover, a direct current-excited brushed motor is provided with a plurality of carbon brush units assembled as described above.

Preferred embodiments of the invention are explained in more detail below on the basis of the drawings. Similar or equivalent components are denoted by the same reference numerals in the figures. In the drawing:

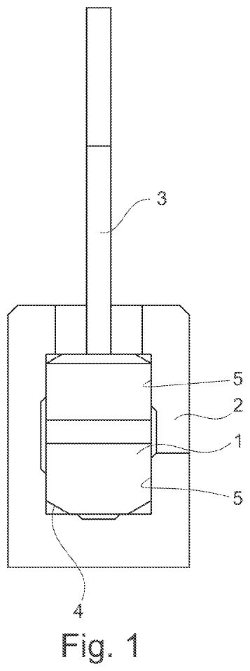

FIG. 1: a plan view of a carbon brush unit with carbon brush holder and carbon brush received therein,

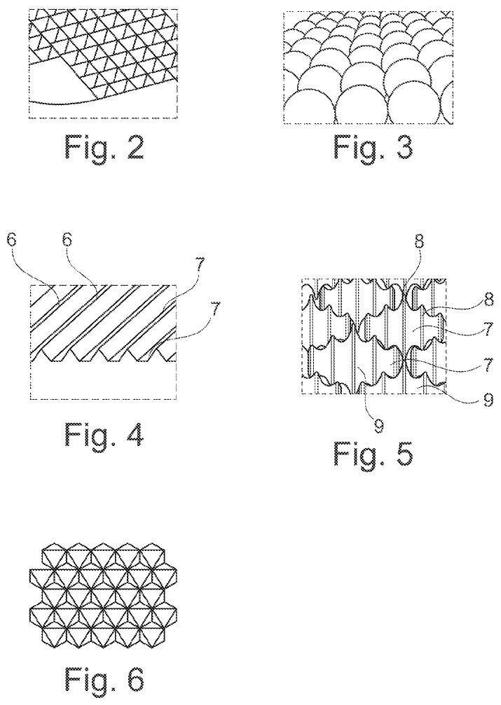

FIG. 2: a schematic representation of a surface with pyramid-shaped protrusions,

FIG. 3: a schematic representation of a surface with spherical protrusions,

FIG. 4: a schematic representation of a roof-shaped rib structure,

FIG. 5: a schematic representation of a shark skin-like rib structure,

FIG. 6: a schematic representation of a trioctaedric octahedron layer,

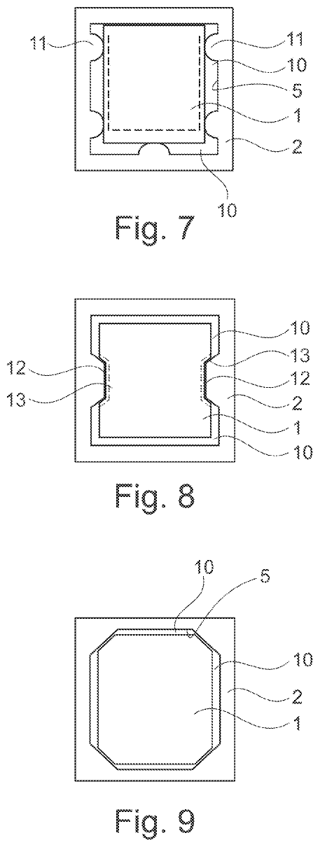

FIG. 7: a longitudinal section through a carbon brush unit with carbon brush holder and carbon brush,

FIG. 8: a longitudinal section through a further carbon brush unit and

FIG. 9: a longitudinal section through a third carbon brush unit.

A conventional carbon brush unit is represented in FIG. 1 with a carbon brush 1 received in a carbon brush holder 2. The carbon brush holder 2 is arranged on a support plate (not represented) of a brush holder unit and aligned radially to the rotational axis of the rotor. The brush holder unit surrounds the rotor. In each case one connection lead 3 is guided from the carbon brushes 1 held in the holders 2 to an electric component held on the support plate. The carbon brush 1 is arranged in the carbon brush holder 2 with certain tolerance conditions.

For the targeted heat dissipation in the carbon brush holder 2, air channels are provided according to the invention between the outer side 4 of the carbon brush 1 and the inner side 5 of the carbon brush holder 2.

The air channels can for example be formed by nanostructuring of the surface of the outer side 4 of the carbon brush 1. Through the nanostructuring, the surface is enlarged and the contact surface to the carbon brush holder 2 is reduced. The nanostructuring preferably has structure periods in a range of between 500-2000 nm. The nanostructuring can preferably be produced with laser interference. FIGS. 2 to 6 show possible structurings of the surface of the outer side 4 of the carbon brush 1. The nanostructuring can for example comprise pyramid-shaped protrusions, as shown in FIG. 2, which form a punctiform support. The pyramids are strung together here at their side edges, whereby a continuous pattern is formed.

It is also conceivable to use spherical protrusions, as represented in FIG. 3. The spheres of a row are here preferably arranged offset to the following row by half the distance between two adjacent spheres.

Roof-shaped ribs 6 are represented in FIG. 4, which form a linear support and straight air channels 7 running parallel to one another. The ribs 6 run here in the direction of the desired heat dissipation or heat current.

A significantly more complex embodiment is depicted in FIG. 5. The cooling channels 7 are constructed in the manner of shark skin. The cooling channels are formed by parallel running ribs 8 which are not formed continuously here, but rather on panels (scales) 9, which are in turn arranged offset to one another. The ribs 8 here also run preferably in the direction of the desired heat dissipation or the heat current.

It is also conceivable to use trioctaedric octahedron layers and therefore to form air channels between the carbon brush holder and the carbon brush (see FIG. 6). These layers can be produced by surface treatment for example by laser interference or be applied as surface coating for example with layer silicates.

In further embodiments, air channels 10 are formed by reducing the contact surface by adapting the carbon brush geometry and/or carbon brush holder geometry. FIGS. 7 to 9 show possible exemplary embodiments.

In FIG. 7, a carbon brush 1 that is substantially rectangular in the longitudinal section to the rotational axis of the rotor is represented in a carbon brush holder 2. The carbon brush holder 2 has on the surface of its inner side 5 that is also substantially rectangular in the cross-section projections 11 which are in particular a semi-spherical shape. The carbon brush holder 2 is in contact with the carbon brush 1 only via the projections 11. Air channels 10 are formed between the projections 11 enabling targeted and efficient heat dissipation.

FIG. 8 shows a further embodiment in which the carbon brush 1 on the opposing side in each case has a web 12 and the carbon brush holder 2 in each case has a groove 13, with the contact surface between the two components being limited to the engagement of the webs 12 in the respective groove 13. Outside of the engagement, an air gap 10 is therefore present between the carbon brush holder 2 and the carbon brush 1 via which the heat can be removed.

In an embodiment represented in FIG. 9, the corners of the carbon brush holder 2 that is substantially rectangular in the longitudinal sections are chamfered on the inner side 5 such that in this region an approximately linear-shaped contact with the carbon brush 1 is formed. An air gap 10 is formed between the carbon brush 1 and the carbon brush holder 2 outside of this contact region.

A heat-conductive material is applied on the outer side of the carbon brush 1 at least in the region of the contact surfaces. The coating with this material is represented in FIGS. 7 and 8 by a dashed line. The material can for example be copper, gold, silver or nickel and their alloys that are permitted in the automobile industry.

The carbon brushes 1 preferably primarily consist of carbon with a high proportion of copper. The proportion of copper is preferably in a range between 20% and 40%. In a preferred embodiment, molybdenum sulphide is present, in particular between 2% and 4%, in particular roughly 3%.

It is also conceivable, in addition to the air channels, to provide indirect cooling of the carbon brush holder 2 during the operation of the motor. Indirect cooling takes place by rotating the armature which generates air vortexes. They increase with increasing rotational speed. The air vortexes in the air channels prevent undesired locally-delimited regions with high temperature from developing, what are known as hot spots.

1. A carbon brush unit for a direct current-excited brushed motor, the carbon brush unit including:
a carbon brush; and
a carbon brush holder which is formed to receive the carbon brush,
wherein an outer side of the carbon brush and/or an inner side of the carbon brush holder are formed such that in an assembled state of the carbon brush unit, defined contact regions and air channels located therebetween result between the outer side of the carbon brush and the inner side of the carbon brush holder in order to dissipate heat,
wherein the contact regions are less than 60% of the overall surface of the inner side of the carbon brush holder, and
wherein the outer side of the carbon brush has a nanostructuring which forms the defined contact regions and air channels.

2. The carbon brush unit according to claim 1,
wherein the nanostructuring is formed by means of laser interference.

3. The carbon brush unit according to claim 1,
wherein the nanostructuring has structure periods in a range of between 500 nm and 2000 nm.

4. The carbon brush unit according to claim 1,
wherein the nanostructuring has spherical, pyramid-shaped and/or roof-shaped protrusions.

5. The carbon brush unit according to claim 1,
wherein the nanostructuring is formed in the manner of shark skin.

6. The carbon brush unit according to claim 1,
wherein the nanostructuring is formed by a surface coating.

7. The carbon brush unit according to claim 6,
wherein the surface coating has a trioctaedric octahedron layer.

8. A carbon brush unit for a direct current-excited brushed motor, the carbon brush unit including:
a carbon brush; and
a carbon brush holder which is formed to receive the carbon brush,
wherein an outer side of the carbon brush and/or an inner side of the carbon brush holder are formed such that in an assembled state of the carbon brush unit, defined contact regions and air channels located therebetween result between the outer side of the carbon brush and the inner side of the carbon brush holder in order to dissipate heat,
wherein the contact regions are less than 60% of the overall surface of the inner side of the carbon brush holder, and the carbon brush on the outer side and/or the carbon brush holder on the inner side has a geometry deviating from a geometry that is rectangular in a longitudinal direction, along a rotational axis of a rotor, which in the assembled state forms the contact regions and defined air channels, and
wherein a highly heat-conductive material is applied in the region of the contact regions on the outer side of the carbon brush.

9. The carbon brush unit according to claim 8,
wherein the carbon brush on the outer side and the carbon brush holder on the inner side have at least partially a corresponding geometry which is designed such that the two components are engaged with one another, wherein the engagement provides a defined position of the carbon brush in the carbon brush holder.

10. The carbon brush unit according to claim 9,
wherein the contact regions are limited to the region of the engagement.

11. A direct current-excited brushed motor including a plurality of the carbon brush units according to claim 1.

12. A direct current-excited brushed motor including a plurality of the carbon brush units according to claim 8.
